(19) United States
(12) Patent Application Publication
(10) Pub. No.: US 2024/0157380 A1
(43) Pub. Date: May 16, 2024

(54) COATING DEVICE, CARTRIDGE, COATING GUN BODY, AND METHOD OF EJECTING MIXTURE

(71) Applicant: KAWASAKI MOTORS, LTD., Akashi-Shi (JP)

(72) Inventor: Fumihiro NAKAGAWA, Akashi-Shi (JP)

(73) Assignee: KAWASAKI MOTORS, LTD., Akashi-Shi (JP)

(21) Appl. No.: 18/549,607

(22) PCT Filed: Mar. 28, 2022
(86) PCT No.: PCT/JP2022/015135

§ 371 Date: Sep. 8, 2023

(30) Foreign Application Priority Data
Apr. 14, 2021 (JP) 2021-068467

(51) Int. Cl. B05B 5/04; B05B 3/10; B05B 15/55

(52) U.S. Cl. CPC B05B 5/0407; B05B 3/1035; B05B 15/55

(57) ABSTRACT

A coating device includes: a coating gun including a coating gun body provided with a jet and a cartridge detachably attached to the coating gun body and housing a first coating liquid; a transport body to which the coating gun is attached to move the coating gun to a predetermined coating position; and a relay tube provided to the transport body to connect a coating liquid supply source disposed in a position away from the coating gun and the coating gun. The cartridge includes a lead-out tube leading out the first coating liquid housed in the cartridge, and formed in the coating gun is a mixing space where the first coating liquid housed in the cartridge and the second coating liquid supplied from the coating liquid supply source are mixed is formed on a downstream side of the relay tube and the lead-out tube.

### TECHNICAL FIELD

The present disclosure relates to a technique of mixing and ejecting processing liquids.

### BACKGROUND ART

Patent Document 1 discloses a coating device mixing coating materials supplied from fuel tanks in a coating material mixing part provided in a coating gun and ejecting the mixed coating material from the coating gun.

### PRIOR ART DOCUMENTS

### Patent Document(s)

Patent Document 1: Japanese Patent Application Laid-Open No. 2000-153184

### SUMMARY

### Problem to be Solved by the Invention

Required is further reduction in a loss of a coating liquid in accordance with a coating target or a type of a coating liquid to be used.

Accordingly, an object of the present disclosure is to reduce a loss of a processing liquid in a device mixing and ejecting processing liquids.

### Means to Solve the Problem

A coating device includes: a coating gun including a coating gun body provided with a jet and a cartridge detachably attached to the coating gun body and housing a first coating liquid; a transport body to which the coating gun is attached to move the coating gun to a predetermined coating position; and a relay tube provided to the transport body to connect a coating liquid supply source disposed in a position away from the coating gun and the coating gun so that a second coating liquid supplied from the coating liquid supply source can flow therethrough, wherein the cartridge includes a lead-out tube leading out the first coating liquid housed in the cartridge, and formed in the coating gun is a mixing space where the first coating liquid housed in the cartridge and the second coating liquid supplied from the coating liquid supply source are mixed is formed on a downstream side of the relay tube and the lead-out tube.

According to the coating device, a cartridge is replaced after a cartridge housing a different coating liquid is prepared, thus a mixed coating liquid ejected from the coating gun body can be easily varied in accordance with a coating form. A length of a path through which the first coating liquid flows can be reduced, and the liquid is mixed in the coating gun, thus a region where the first coating liquid has flowed before a replacement of the cartridge can be reduced when the cartridge is replaced, and a region where the first coating liquid is washed before the replacement of the cartridge can be reduced in accordance with the replacement of the cartridge. Accordingly, a washing process can be reduced, and a time until a mixed coating material after the replacement of the cartridge is qualitatively stabilized can be reduced. A loss of a coating liquid can also be reduced.

A cartridge detachably attached to a coating gun body provided with a jet includes: a container body housing a first coating liquid; and a lead-out tube leading out the first coating liquid in the container body, wherein formed in the cartridge are a mixing space where the first coating liquid and a second coating liquid are mixed and a second coating liquid flow path leading the second coating liquid supplied from an outside of the cartridge toward the mixing space, and the lead-out tube leads the first coating liquid in the container body toward the mixing space.

According to the cartridge, a cartridge attached to the coating gun body is replaced after a cartridge housing a different coating liquid is prepared, thus a mixed coating liquid ejected from the coating gun body can be easily varied in accordance with a coating form. A length of a path through which the first coating liquid flows can be reduced, and the liquid is mixed in the coating gun, thus a region where the first coating liquid has flowed before a replacement of the cartridge can be reduced when the cartridge is replaced, and a region where the first coating liquid is washed before the replacement of the cartridge can be reduced in accordance with the replacement of the cartridge. Accordingly, a washing process can be reduced, and a time until a mixed coating material after the replacement of the cartridge is qualitatively stabilized can be reduced. A loss of a coating liquid can also be reduced.

The coating gun body includes an ejection part where a jet from which a coating liquid is ejected is formed, a cartridge attachment part to which a cartridge housing a first coating liquid can be detachably attached, and a relay tube connection part to which a relay tube supplying a second coating liquid from an outside is connected.

According to the coating gun body, a cartridge is replaced after a cartridge housing a different coating liquid is prepared, thus a component of a mixed coating liquid ejected from the coating gun body can be easily varied. A length of a path through which the first coating liquid flows can be reduced, thus a region where the first coating liquid has flowed before a replacement of the cartridge can be reduced when the cartridge is replaced, and a region where the first coating liquid is washed before the replacement of the cartridge can be reduced in accordance with the replacement of the cartridge. Accordingly, a washing process can be reduced, and a time until a mixed coating material after the replacement of the cartridge is qualitatively stabilized can be reduced. A loss of a coating liquid can also be reduced.

A method of ejecting a mixture is a method of ejecting a mixture in a processing liquid ejection system including an ejection gun including an ejection gun body provided with a jet and a cartridge detachably attached to the ejection gun body and housing a first processing liquid and a processing liquid supply source disposed in a position away from an ejection gun and supplying a second processing liquid to an ejection gun body, wherein a mixture made up of the first processing liquid and the second processing liquid supplied from the processing liquid supply source on a downstream side of a lead-out tube leading out the first processing liquid housed in the cartridge is ejected.

According to the method of ejecting the mixture, a cartridge is replaced after a cartridge housing a different first processing liquid is prepared, thus a mixture ejected from the coating gun body can be easily varied. The first processing liquid housed in the cartridge in two liquids to be mixed can be supplied to the ejection gun body from the cartridge, thus a length of a path through which the first processing liquid flows can be reduced. The first processing liquid in the cartridge is mixed with the second processing liquid on the downstream side of the lead-out tube, and ejected from the jet. The length of the path through which the first processing liquid passes is small, and the liquid is mixed on the downstream side of the lead-out tube, thus a region where the first processing liquid has flowed before a replacement of the cartridge can be reduced when the cartridge is replaced, and a region where the first processing liquid is washed before the replacement of the cartridge can be reduced in accordance with the replacement of the cartridge. Accordingly, a washing process can be reduced, and a time until a mixture after the replacement of the cartridge is qualitatively stabilized can be reduced. A loss of a processing liquid can also be reduced.

### Effects of the Invention

A loss of a processing liquid can be reduced in a device mixing and ejecting processing liquids.

### BRIEF DESCRIPTION OF DRAWINGS

FIG. 1 An explanation diagram illustrating a coating device according to a first embodiment.

FIG. 2 A cross-sectional view illustrating a coating gun body according to the first embodiment.

FIG. 3 A cross-sectional view illustrating a cartridge according to the first embodiment.

FIG. 4 A cross-sectional view illustrating a coating gun according to a second embodiment.

FIG. 5 A cross-sectional view illustrating a coating gun according to a third embodiment.

### DESCRIPTION OF EMBODIMENT(S)

### First Embodiment

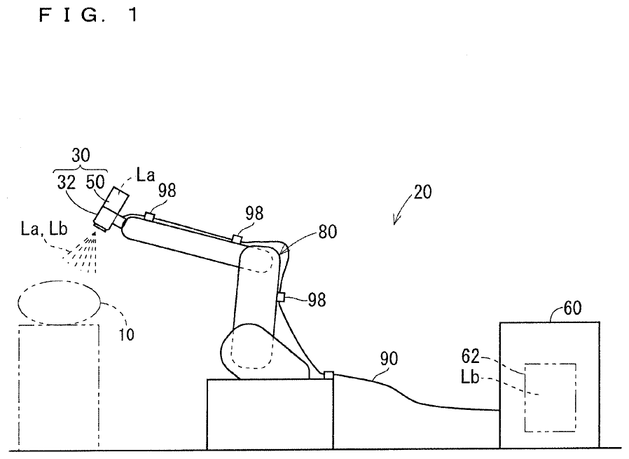

A coating device according to a first embodiment is described hereinafter. FIG. 1 is an explanation diagram illustrating a coating device 20.

A coating device 20 is a device ejecting a mixture made up of a first coating liquid and a second coating liquid to a coating target object 10, thereby coating the coating target object 10. The coating target object 10 includes a coating gun 30, a transport body 80, and a relay tube 90. The coating gun 30 mixes the first coating liquid and the second coating liquid, and ejects a mixture thereof as a coating liquid. For example, a coating form of the coating target object 10 may be frequently changed in accordance with an order volume or a production plan for various coating form objects. The present coating device 20 is an example of a device coating the coating target object 10 in accordance with a change of the order volume or the production and manufacturing a coating object corresponding to the required coating form.

The transport body 80 is a device moving the coating device 20 so that the coating device 20 is directed to a coating region in the coating target object 10. The transport body 80 is a manipulator in which arm parts are connected via joints or a multiple joint robot including a manipulator. The coating gun 30 is attached to a distal end of the arm part. The coating gun 30 is moved toward a predetermined coating position in accordance with the coating region in the coating target object 10 by the driving of the transport body 80. Thus, the coating gun 30 can function as an end effector attached to a distal end 1 of the manipulator.

Any device is applicable to the transport body 80 as long as it can move the coating gun 30, thus needs not be the multiple joint robot. In the present embodiment, a coating target surface of a fuel tank etc. is a curved surface. In this case, it is preferable that the transport body has a configuration of being movable on a three-dimensional coordinate perpendicular to the coating gun and a posture of the coating gun can be changed around three axes. For example, the transport body 80 may be an orthogonal robot. For example, the transport body 80 may be a device moving the coating gun 30 around only one axis or in only one direction. An already-existing manipulator may be used as the transport body.

The coating gun 30 includes a cartridge 50 housing the first coating liquid, and the first coating liquid is supplied from the cartridge 50. The first coating liquid may be supplied from the cartridge 50 by pressing the first coating liquid housed in a container body 52 by a fluid supplied from an outside, for example. A configuration example of the cartridge 50 supplying the first coating liquid is described hereinafter more specifically. A coating liquid supply source 60 housing the second coating liquid is disposed in a fixed position away from the coating gun 30. The coating liquid supply source 60 includes a tank 62 housing the second coating liquid and a pump sending the second coating liquid in the tank 62. The relay tube 90 is connected to a supply port of the second coating liquid in the coating liquid supply source 60 and a relay tube connection part 34a in the coating gun 30. Accordingly, the relay tube 90 connects the coating liquid supply source 60 and the coating gun 30. The second coating liquid housed in the tank 62 is pressed and sent to the relay tube 90 by a pump. The second coating liquid flows in the relay tube 90 to be supplied to the coating gun 30. A housing amount of a liquid housed in the cartridge 50 may be set to be smaller than that of a liquid in the tank.

The relay tube 90 is provided to the transport body 80. For example, an intermediate part of the relay tube 90 is supported along an arm part of the transport body 80, thereby being provided thereto. The relay tube 90 is attached to an outer side of the arm part via a tube attachment part 98, for example. The tube attachment part 98 may have a structure including a holder housing the relay tube 90 and an attachment part attached to the arm part with a screw or a fitting structure, for example. The relay tube 90 may be passed through an inner side of an exterior of the arm part. The relay tube 90 moves together with the arm part in accordance with a movement of the coating gun 30. When the transport body 80 and the coating liquid supply source 60 are away from each other, the relay tube 90 is disposed along an area therebetween. The relay tube 90 is a tube made of resin or metal, for example. A length of the relay tube 90 is set in accordance with a distance from the coating gun 30 to the coating liquid supply source 60, and is equal to or larger than 10 m and equal to or smaller than 20 m, for example.

The first coating liquid supplied from the coating gun 30 and the second coating liquid supplied from the coating liquid supply source 60 via the relay tube 90 are mixed in the coating gun 30, and ejected toward the coating target object 10. Accordingly, the mixture coats the coating target object 10.

The cartridge 50 in the coating gun 30 is detachably attached to a coating gun body 32. Thus, when a type of the first coating liquid mixed in the mixture is desired to be changed, such a change can be achieved by replacing the cartridge 50 which has been attached with the cartridge 50 housing the first coating liquid to be changed. In the meanwhile, the coating liquid supply source 60 is disposed in a position away from the coating gun 30. Thus, there is a less limitation, such as a limitation regarding a size or a weight, for example, in the coating liquid supply source 60 when being attached to the coating gun body 32. For example, a limitation regarding a capacity of the second coating liquid housed in the coating liquid supply source 60 can be reduced in the coating liquid supply source 60. Accordingly, the second coating liquid can be continuously supplied without running out of stock even when a frequent resupply is not performed, for example.

A configuration of each part is described more specifically.

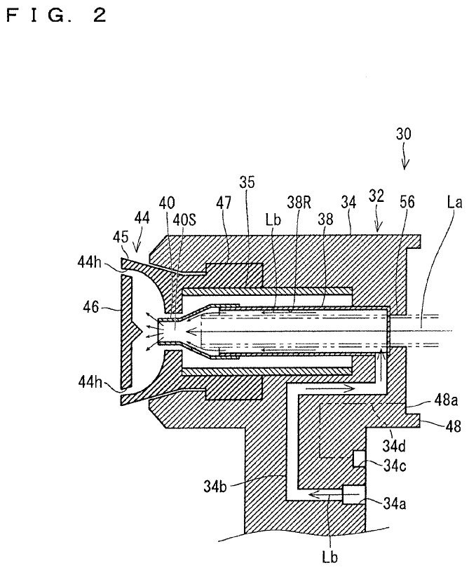

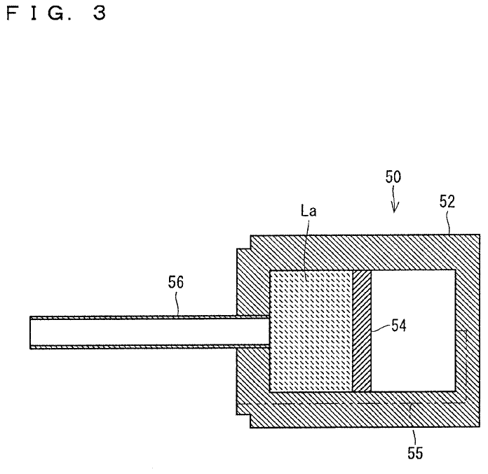

FIG. 2 is a cross-sectional view illustrating the coating gun body 32. FIG. 3 is a cross-sectional view illustrating the cartridge 50.

The coating gun 30 includes the coating gun body 32 and the cartridge 50.

The coating gun body 32 is provided with a jet 44h. A mixing space 40S in which a first coating liquid La and a second coating liquid Lb are mixed is formed in the coating gun body 32. The mixing space 40S is provided on a downstream side of a flow path of the second coating liquid Lb in relation to the relay tube 90.

The cartridge 50 is detachably attached to the coating gun body 32. The cartridge 50 includes a lead-out tube 56 leading the first coating liquid La housed in the cartridge 50 to an outside of the cartridge 50. The mixing space 40S described above is provided on a downstream side of a flow path of the first coating liquid in relation to the lead-out tube 56. Then, the first coating liquid La and the second coating liquid Lb are mixed in the mixing space 40S on the downstream side in relation to the relay tube 90 and the lead-out tube 56, and a mixture thereby obtained is ejected from the jet 44h. The cartridge 50 is preferably provided with a valve suppressing leakage of a coating liquid from the lead-out tube 56 in a state where the cartridge 50 is attached to the coating gun body 32.

Any liquid is applicable to the first coating liquid La. An example of the first coating liquid La is a liquid corresponding to a change of a coating form of the coating target object 10, and is a liquid called a base compound. The change of the coating form can be grasped by an outer appearance of a coating target object, thus the first coating liquid La may also be considered a liquid as a factor having influence on the outer appearance of the coating target object 10. More specifically, the first coating liquid is a liquid containing a pigment or a colorant for coloring a surface, a liquid containing a luster material reflecting light in a coating film such as an aluminum flake or a glazing agent, a color clear coating liquid containing a color agent, a frosting agent for frosting a surface, for example. The first coating liquid may be a liquid having influence on a function (ultraviolet absorption properties or endurability, for example) of a surface of the coating target object. The first coating liquid may be appropriately replaced in accordance with a special effect of a color (luminosity or color saturation) to be applied on a surface of the coating target object 10 or light reflection of a luster degree or a desired special effect such as ultraviolet absorption properties or durability, for example.

Any liquid is applicable to the second coating liquid Lb. An example of the second coating liquid Lb is a liquid used more in common than the first coating liquid La even when the coating form of the coating target object 10 is changed, and is a liquid called a cure agent, for example. The cure agent may be considered a factor hardening a mixture in a state of being mixed with a base compound. The cure agent has a function of being mixed with a base compound to entrench the base compound to the surface of the coating target object 10. Thus, when the base compound is replaced, the cure agent is mixed with a base compound after the replacement, and can continuously have a function of entrenching the base compound after the replacement to the surface of the coating target object 10. Thus, the cure agent is not replaced regardless of whether or not the base compound is replaced, but is used as it is. The above configuration does not exclude the replacement of the second coating liquid Lb, however, the second coating liquid Lb may be replaced in accordance with a replacement of the first coating liquid La or a change of the coating target object 10, for example. A liquid replaced less frequently than the first coating liquid is preferably selected as the second coating liquid. The second coating liquid may be set to a liquid used in common to correspond to various coatings.

More specifically describing the coating gun body 32, the coating gun body 32 includes a body 34, a second coating liquid tube 38, a mixing part 40, and an ejection part 44.

The body 34 is formed into a shape elongated in one direction such as a columnar shape, for example. An attachment part protruding from a part of an outer periphery of the body 34 is attached to the transport body 80.

A through hold extending along a central axial direction of the body 34 is formed in the body 34. One end part of the through hole in a longitudinal direction is larger than an intermediate part of the through hole in the longitudinal direction. The other end part of the through hole in the longitudinal direction is smaller than the intermediate part of the through hole in the longitudinal direction.

A support cylindrical part 35 is attached to the intermediate part of the through hole in the longitudinal direction. One end part of the support cylindrical part 35 extends to a side of one end part of the through hole in the longitudinal direction. A gap is provided between one end part of the support cylindrical part 35 and an inner periphery surface on a side of one end part of the through hole in the longitudinal direction. A rotational drive part 47 is provided to the gap. The rotational drive part 47 is an air motor or an electric motor, for example, and is attached to one end part of the support cylindrical part 35 or the body 34 while its rotational movement is stopped. The rotational drive part 47 rotatably supports the ejection part 44 on a one end side of the body 34.

The ejection part 44 is a part in which a jet 44h of a mixture is formed. An example that the ejection part 44 is a bell cup is described in the present embodiment. A bell cup 44 forms a residence space in which the mixture resides, and discharges the mixture residing in the residence space radially outward by centrifugal force due to rotation. More specifically, the bell cup 44 includes a cup part 45 and an ejection wall part 46. The cup part 45 includes an inner peripheral surface gradually broadening from a bottom toward an opening edge. A through hole is formed in the bottom of the cup part 45. The ejection wall part 46 is a plate-like member provided in a position closing an opening in the cup part 45. The jet 44h is formed in an annular connection part between the cup part 45 and the ejection wall part 46. For example, the jets 44h are formed side by side at intervals along the annular connection part. The rotational drive part 47 described above rotatably supports the bell cup 44 on an outer side of a distal end of the support cylindrical part 35 in one end part of the body 34. In this state, the opening in the bottom of the cup part 45 is connected to a space in the intermediate part of the body 34 in an axial direction.

The second coating liquid tube 38 leads the second coating liquid Lb supplied from the coating liquid supply source 60 via the relay tube 90 toward the mixing space 40S in the mixing part 40. In the present embodiment, the second coating liquid tube 38 is formed into a tubular shape (cylindrical shape). The second coating liquid tube 38 is provided to extend from a center part of a bottom of the body 34 toward the opening in the bottom of the cup part 45. A distal end of the second coating liquid tube 38 is located closer to a center of the body 34 in an axial direction than the opening in the bottom of the cup part 45. A second coating liquid flow path 38R is formed in the second coating liquid tube 38. The mixing part 40 is provided to the distal end of the second coating liquid tube 38.

A relay tube connection part 34a in which one end part of the relay tube 90 is connected is provided to the body 34. The relay tube connection part 34a is a tube joint, for example. Formed in the body 34 is a flow path 34b reaching an inner side of the second coating liquid tube 38 from the relay tube connection part 34a. The flow path 34b may be a tube routed in the body 34, or may also be formed by forming a hole in the body 34. The second coating liquid Lb supplied from the coating liquid supply source 60 is led into the second coating liquid flow path 38R in the second coating liquid tube 38 via the relay tube 90, the relay tube connection part 34a, and the flow path 34b. The second coating liquid Lb is led toward the mixing part 40 by the second coating liquid flow path 38R.

The lead-out tube 56 is provided to the cartridge 50 in the present embodiment. The other end part of the through hole in the body 34 is formed to have a size so that the lead-out tube 56 can be inserted therein. A sealing component (for example, a rubber ring) preventing leakage of the liquid may be provided between an inner peripheral surface of the other end part of the through hole in the body 34 and an outer peripheral surface of the lead-out tube 56. The lead-out tube 56 passes through the second coating liquid tube 38 to reach a side of a distal end of the second coating liquid tube 38. In this state, the second coating liquid tube 38 surrounds the lead-out tube 56 at intervals. In the present embodiment, the distal end of the lead-out tube 56 protrudes more than a side of the distal end of the second coating liquid tube 38, however, this configuration is not necessary. The second coating liquid Lb passes through a tubular space between the inner peripheral surface of the second coating liquid tube 38 and the lead-out tube 56 to be led to the side of the distal end of the second coating liquid tube 38.

The mixing part 40 is a part forming the mixing space 40S in which the first coating liquid La and the second coating liquid Lb are mixed. In the present embodiment, the mixing part 40 is continuously formed with the distal end of the second coating liquid tube 38. The mixing part 40 is formed into a tubular shape that is opened at opposite ends along an axial direction. A base end part of the mixing part 40 is formed into an annular shape so as to be externally fitted to the distal end of the second coating liquid tube 38. An opening of the second coating liquid tube 38 on the side of the distal end and an opening of the lead-out tube 56 on a side of the distal end are located in the mixing space 40S in the mixing part 40. The distal end of the mixing part 40 extends from the distal end of the second coating liquid tube 38 to an outer side in an axial direction thereof. Thus, the mixing part 40 surrounds an outer periphery on an extended line of each of the opening on the side of the distal end of the second coating liquid tube 38 and the opening on the side of the distal end of the lead-out tube 56. The first coating liquid La passing through the lead-out tube 56 and the second coating liquid Lb passing through the second coating liquid tube 38 join together in the mixing space 40S in the mixing part 40 and mixed.

The mixing part 40 includes a reduced diameter part gradually narrowing toward the side of the distal end (a downstream side of the coating liquid in a flow direction). A distal end of the reduced diameter part is provided with an outlet part continuously having the same diameter. An opening area of the outlet part is preferably smaller than a total area of an opening of a flow path (a flow path in the lead-out tube 56 and the second coating liquid flow path 38R) in which a fluid to be mixed flows.

In this manner, used is the coating liquid mixing device including the supply tube part (the lead-out tube 56 and the second coating liquid tube 38) including the flow paths (the flow path in the lead-out tube 56 and the second coating liquid flow path 38R), with the openings on the side of the distal ends, in which each of the coating liquids La and Lb flows and the mixing part 40 continuously formed with the outlet part of the supply tube part so that the coating liquids La and Lb flowing in the flow paths are supplied to the inner space and including the reduced diameter part in which the inner space narrows toward the outlet side so that the opening area is smaller than the total area of the opening of the flow paths, thus the coating liquids La and Lb are guided in a direction in which they are mixed with each other while increasing a flow velocity in the inner space in the mixing part 40. By deflecting the coating liquids La and Lb as described above, multiple types of the coating liquids La and Lb can be mixed together. By deflecting the coating liquids flowing through the mixing part 40 and mixing them as described above, a region where the coating liquids La and Lb have a minimum flow velocity can be prevented compared with a case where the baffle for agitation is provided. Accordingly, a clog of the coating liquids La and Lb in the mixing part 40 can be prevented. The mixing part 40 can be brought close to the bell cup 44 as an example of the jet, and points where the mixture flows can be reduced. Accordingly, the configuration of the mixing part 40 can be simplified, and the mixing part 40 can be easily washed.

The outlet part passes through the opening in the bottom of the cup part 45 of the bell cup 44 to reach an inner side of a residence space in the bell cup 44. Thus, the liquid mixed in the mixing space 40S is ejected from the opening on the side of the distal end of the mixing part 40 into the residence space in the bell cup 44. The mixture ejected from the mixing part 40 collides with an inner surface of the ejection wall part 46 on a downstream side of an ejection direction in the residence space in the bell cup 44. The bell cup 44 rotates at high speed, thus the mixture in the residence space adhering to the inner surface of the bell cup 44 move radially outward by centrifugal force while rotating along with the bell cup 44. The mixture goes down the inner surface of the bell cup 44, and is ejected to an outside of the bell cup 44 from the jet 44h by centrifugal force.

The coating gun body 32 is provided with a cartridge attachment part 48 which can detachably attach the cartridge 50. The cartridge attachment part 48 includes a concave part 48a into which the cartridge 50 can be fitted, for example. The cartridge attachment part 48 may have a locking structure of suppressing detachment of the cartridge 50. The locking structure may be a structure that a displaceable locking part is provided to the coating gun body 32, a locking receiving part to which the locking part can be locked is provided to the cartridge 50, and the locking part is displaced in a state where the cartridge 50 is attached to the cartridge attachment part 48, thereby being locked to the locking receiving part. It is also applicable that the locking part is provided to the cartridge 50 and the locking receiving part is provided to the coating gun body. The cartridge 50 may be kept in a state of being attached to the coating gun 30 by a screw.

The cartridge 50 includes the container body 52 and the lead-out tube 56.

A space in which the first coating liquid La can be housed is formed in the container body 52. The cartridge 50 is moved by the transport body 80 in a state of being attached to the coating gun body 32, thus there is a possibility that a limitation regarding a size or a weight is larger in the cartridge 50 than in the coating liquid supply source 60. Thus, a housing capacity of the liquid in the cartridge 50 is set to be smaller than that of the liquid in the tank 62 in the coating liquid supply source 60, for example. The lead-out tube 56 protrudes from one end part of the container body 52. A flow path leading the first coating liquid La to an outside is formed in the lead-out tube 56. The opening on a base end side of the lead-out tube 56 is connected to a space in the container body 52. Thus, the first coating liquid La in the container body 52 may be led to an outside through the lead-out tube 56.

The first coating liquid La in the container body 52 is sent to the outside through the lead-out tube 56. The following structure is incorporated into the container body 52 as a configuration of sending the first coating liquid La, for example. Provided in the container body 52 is a piston-like member 54 which can be reciprocated in the container body 52 while a space in the container body 52 is partitioned.

The first coating liquid La is housed in a space in the container body 52 on one side partitioned by the piston-like member 54. Formed in the container body 52 is a fluid path 55 reaching a space in the container body 52 on the other side partitioned by the piston-like member 54. An opening on one side of the fluid path 55 faces the coating gun body 32, and an opening on the other side of the fluid path 55 faces the space in the container body 52. An external fluid connection part 34c is provided to the coating gun body 32. Formed in the coating gun body 32 is an external fluid flow path 34d directed to a part facing the opening on one side of the fluid path 55 from the external fluid connection part 34c.

Air or a fluid is used as an external fluid to send the first coating liquid La. An external fluid supply source not shown in the drawings includes an external fluid housing tank and a pump, for example, and an external fluid tube extending from the external fluid supply source is connected to the external fluid connection part 34c described above. The external fluid supplied from the external fluid supply source is sent to the space on the other side partitioned by the piston-like member 54 in the container body 52 via the external fluid tube, the external fluid connection part 34c, the external fluid flow path 34d, and the fluid path 55. When the external fluid is sent to the inner side of the container body 52 from the external fluid supply source, the piston-like member 54 is pressed and moved, thus the piston-like member 54 can send the first coating liquid La in the container body 52 to the outside via the lead-out tube 56.

The configuration of sending the first coating liquid La in the container body 52 is not limited to the example described above. For example, it is applicable that gas is sealed in the container body 52 in a compressed state, and the first coating liquid La is sent to the outside by pressure of the gas via the lead-out tube 56.

According to the coating device 20 and the coating gun body 32, the cartridges 50 each housing the different first coating liquid La are prepared in performing the coating processing. Then, the cartridge 50 corresponding to the coating form in the coating target object 10 is attached to the coating gun body 32. In this state, the first coating liquid La supplied from the cartridge 50 and the second coating liquid Lb supplied from the coating liquid supply source 60 are mixed in the mixing space 40S in the coating gun body 32. The mixed liquid (mixed coating liquid) is ejected from the jet 44h of the bell cup 44. Accordingly, the mixed coating liquid is supplied to the surface of the coating target object 10, and the coating processing is performed. When the coating form in the coating target object 10 is varied, the cartridge 50 which has been attached is replaced with the other cartridge 50 corresponding to the coating form after the change. Then, the first coating liquid La supplied from the cartridge 50 after the replacement and the second coating liquid Lb supplied from the coating liquid supply source 60 are mixed in the mixing space 40S in the coating gun body 32, and the coating processing can be performed in the manner similar to the above description. In this manner, the cartridge 50 is replaced, thus the mixed coating liquid ejected from the coating gun body 32 can be easily varied in accordance with the coating form.

The first coating liquid La housed in the cartridge 50 can be supplied to the coating gun body 32 without intervention of the relay tube 90, thus a length of the path through which the first coating liquid La flows can be reduced. The first coating liquid La in the cartridge 50 is mixed with the second coating liquid Lb in the mixing space 40S provided to the coating gun 30, and is ejected from the jet 44h. Accordingly, the length of the path through which the mixed coating liquid can also be reduced. As described above, the length of the path through which the first coating liquid La flows is small, and the first coating liquid La and the second coating liquid Lb are mixed in the coating gun 30, thus a region where the first coating liquid La before the replacement has flowed is reduced in the replacement of the cartridge 50. Accordingly, a region where the first coating liquid La is washed before the replacement is reduced in accordance with the replacement of the cartridge 50. Accordingly, a washing process can be reduced in the replacement of the cartridge 50, and a time until the mixed coating liquid after the replacement of the cartridge 50 is qualitatively stabilized can be reduced. A loss of the first coating liquid La can also be reduced.

For example, assumed is a case where the first coating liquid and the second coating liquid are mixed in a position different from the coating gun and supplied to the coating gun. In this case, a tank of an external mixed coating liquid supply source is replaced or washed and a relay hose is washed every time the first coating liquid La is replaced, for example, thus an operation therefor and consumption of a liquid for washing also increase. In the present coating device 20, the tank 62 needs not be replaced or washed, and the relay tube 90 needs not be washed in the replacement of the cartridge 50.

Also assumed is a case where a mixed coating liquid made up of the first coating liquid and the second coating liquid is housed in a cartridge attached to the coating gun body, and the mixed coating liquid is supplied from the cartridge, for example. In the case, there is a possibility that the mixed coating liquid is solidified in the cartridge more easily than the first coating liquid La. Thus, when the cartridge 50 described above is considered as an example, there is a possibility that the piston-like member 54 does not move in the cartridge 50. There is a limitation regarding a size and a weight in the cartridge attached to the coating gun body, thus there is also a limitation regarding a quantity of the mixed coating liquid which can be housed in the cartridge. Thus, when the mixed coating liquid is supplied from the cartridge, there is a possibility of a lack of liquid easily.

In contrast, in the coating device 20, the first coating liquid La which is hardly solidified is housed in the cartridge 50, and the second coating liquid Lb which is easily solidified is supplied from the coating liquid supply source 60, thus solidification of the first coating liquid La in the cartridge 50 can be suppressed. The coating liquid supply source 60 is disposed in a position away from the coating gun 30, thus there is a less limitation regarding a housing amount of the second coating liquid Lb. The first coating liquid La supplied from the cartridge 50 and the second coating liquid Lb supplied from the coating liquid supply source 60 are mixed in the coating gun 30 and ejected, thus a lack of the first coating liquid La and the second coating liquid Lb occurs hardly compared with a case of supplying the mixed coating liquid from the cartridge. Accordingly, a coating operation of ejecting the mixed coating liquids in which the first coating liquid La is changed can be effectively performed.

From this point, it is sufficient that the first coating liquid La corresponding to the change of the coating form of the coating target object 10 is housed in the cartridge 50 and the second coating liquid Lb used in common even when the coating form of the coating target object 10 is changed is supplied via the relay tube 90. Accordingly, the number of replacements of the cartridge 50 is suppressed compared with the case where the second coating liquid Lb or the mixed coating liquid is housed in the cartridge 50. The second coating liquid Lb used in common even when the coating form of the coating target object is changed is supplied via the relay tube 90, and a washing liquid needs not be replaced in the relay tube 90.

For example, assumed is a coating operation accompanied with an operation of frequently changing a color. In this case, a base compound is housed in the cartridge 50, and a cure agent is housed in the coating liquid supply source 60, thus the cartridge 50 housing the base compound can be replaced every operation of changing a color, and the coating liquid supply source 60 housing the cure agent can be continuously used regardless of the operation of changing a color. Accordingly, even when the operation of changing a color occurs, only the base compound remaining in the cartridge 50 is wasted, thus a residual amount of liquid of the base compound can be reduced compared with a case of supplying the mixed coating liquid from the coating liquid supply source. A time and effect other than the replacement of the cartridge 50 for the operation of changing a color such as the replacement of the coating liquid supply source 60 caused by a lack of cure agent or an operation of resupplying the cure agent, for example, can be reduce as much as possible. Thus, both reduction of a residual amount of liquid of the base compound and reduction of the time and effect of the operation of supplying the cure agent are achieved.

The coating gun body 32 is provided with the mixing space 40S and the second coating liquid flow path 38R. Thus, the first coating liquid La and the second coating liquid Lb are mixed near the jet 44h. Accordingly, an amount of waste of an unused mixed coating liquid can be suppressed compared with a case where two coating liquids are previously mixed and then supplied to a coating device. The configuration of the cartridge can be simplified compared with a case where the cartridge is provided with the mixing space and the second coating liquid flow path.

The cartridge 50 is provided with the lead-out tube 56 leading the first coating liquid La toward the mixing space 40S. Thus, the container body 52 housing the first coating liquid La and the lead-out tube 56 leading out the first coating liquid La are replaced by replacing the cartridge 50. Thus, the operation of washing the coating gun body 32 in the replacement of the cartridge 50 is easily performed.

The ejection part 44 is the bell cup 44, thus the mixed coating liquid can be atomized by centrifugal force due to rotation of the bell cup 44 and ejected without air for atomization, for example.

It is also applicable that the first coating liquid La described above is not a liquid for coating but is a first processing liquid. It is also applicable that the second coating liquid Lb is not a liquid for coating but is a second processing liquid. In this case, it may be considered that the coating gun body 32 is the ejection gun body 32, the coating gun 30 is the ejection gun 30, the cartridge 50 is the cartridge 50 housing the first processing liquid, and the coating liquid supply source 60 is the processing liquid supply source 60 housing the second processing liquid. A system including the ejection gun body 32, the ejection gun 30, the cartridge 50, and the processing liquid supply source 60 may be considered as a processing liquid ejection system. Executable in the processing liquid ejection system is a method of ejecting a mixture in which a mixture made up of the first processing liquid La and the second processing liquid Lb supplied from the processing liquid supply source 60 are mixed on a downstream side of the lead-out tube 56 leading out the first processing liquid La housed in the cartridge 50 is ejected.

In the manner similar to the above description, also in the method of ejecting the mixture, a washing process can be reduced, and a time until the mixture after the replacement of the cartridge 50 is qualitatively stabilized can be reduced. A loss of a processing liquid can also be reduced.

### Second Embodiment

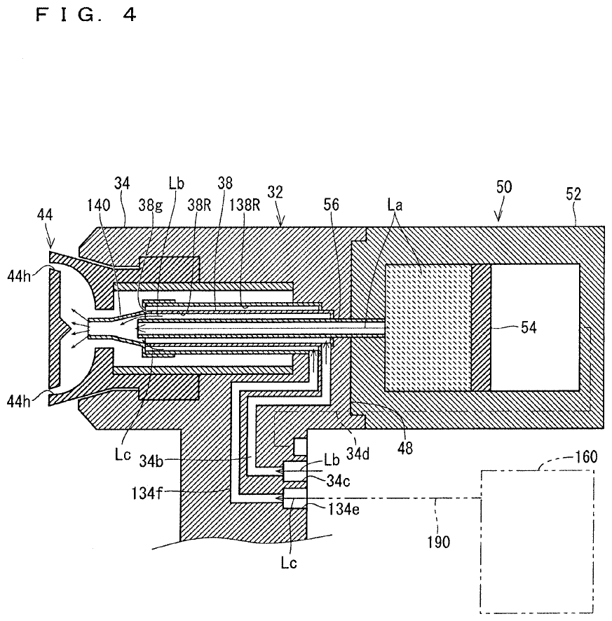

A coating device according to a second embodiment is described. FIG. 4 is a cross-sectional view illustrating a coating gun 130 according to a second embodiment. In the description of the present embodiment, the same reference numerals are assigned to the similar constituent elements described in the first embodiment, and the description thereof will be omitted.

In the coating gun 130 according to the second embodiment, a configuration for flowing a washing liquid is added to the coating gun 30 according to the first embodiment.

The coating gun 130 includes a washing liquid tube 138. A washing liquid flow path 138R through which the washing liquid flows is formed in the washing liquid tube 138. A washing liquid Lc flowing through the washing liquid flow path 138R washes at least a part of a flow path through which the first coating liquid La flows. Herein, the first coating liquid La passes through the lead-out tube 56 and is ejected to an outside via a space in a mixing part 140 and the space in the bell cup 44. The space in the mixing part 140 and the space in the bell cup 44 are examples of the flow path through which the first coating liquid La flows. The washing liquid Lc passes through the space in the mixing part 140 and the space in the bell cup 44 from the washing liquid flow path 138R in the washing liquid tube 138 to wash inner surfaces thereof.

More specifically, the washing liquid tube 138 is formed into a tubular shape (cylindrical shape). The washing liquid tube 138 extends from a part closer to a center of the second coating liquid tube 38 in relation to a base end thereof toward the distal end of the second coating liquid tube 38 while surrounding an outer periphery of the second coating liquid tube 38 at intervals. Herein, a position of an opening of a distal end of the washing liquid tube 138 coincides with a position of the opening of the distal end of the second coating liquid tube 38. A washing liquid flow path 138R is formed between an inner peripheral surface of the washing liquid tube 138 and an outer peripheral surface of the second coating liquid tube 38.

A base end part of the mixing part 140 corresponding to the mixing part 40 is opened larger than that of the mixing part 40. The base end part and a reduced diameter part of the mixing part 140 are continuously formed via a step part. The distal end of the washing liquid tube 138 is fitted into the base end part of the mixing part 140. A concave part 38g may be intermittently formed in an opening part of the second coating liquid tube 38 in a circumferential direction.

The washing liquid Lc passing through the washing liquid flow path 138R in the washing liquid tube 138 passes through an area between the distal end of the second coating liquid tube 38 and the step part of the mixing part 140 to be supplied to an inner side of the reduced diameter part of the mixing part 140 and an inner side of the distal end thereof. At this time, the washing liquid passes through the concave part 38g of the opening part in the second coating liquid tube 38, thus is deflected radially inward of the mixing part 140, and the inner peripheral surface of the mixing part 140 is effectively washed. The washing liquid is supplied from the mixing part 140 to the inner side of the bell cup 44 to wash the surface in the bell cup 44, and is discharged to the outside.

A relay tube connection part 134e in which one end part of the washing liquid supply relay tube 190 is connected is provided to the body 34. The relay tube connection part 134e is a tube joint, for example. Formed in the body 34 is a flow path 134f reaching the inner side of the washing liquid tube 138 from the relay tube connection part 134e. The flow path 134f may be a tube routed in the body 34, or may also be formed by forming a hole in the body 34. A washing liquid supply source 160 including a tank housing a washing liquid and a pump sending the washing liquid, for example, is provided in a position away from the present coating gun 130. The washing liquid supplied from the washing liquid supply source 160 is led into the washing liquid flow path 138R in the washing liquid tube 138 via the washing liquid supply relay tube 190, the relay tube connection part 134e, and the flow path 134f.

According to the present embodiment, when the cartridge 50 is replaced, the first coating liquid La before the replacement adheres to the inner side of the mixing part 140 and the inner side of the bell cup 44. The washing liquid supplied via the washing liquid flow path 138R can wash the inner side of the mixing part 140 and the inner side of the bell cup 44 to remove the first coating liquid La before the replacement. The lead-out tube 56 which has led the first coating liquid La before the replacement into the mixing part 140 may be replaced together with the cartridge 50. Thus, the operation of washing the coating gun body 32 can be easily performed in the replacement of the cartridge 50.

In the present embodiment, the washing liquid flow path 138R may be opened toward the inner side of the bell cup 44. In this case, the washing liquid can wash mainly the bell cup 44.

It is not necessary to supply the washing liquid from the external washing liquid supply source 160, however, the washing liquid may be supplied from a washing liquid cartridge attached to the coating gun.

### Third Embodiment

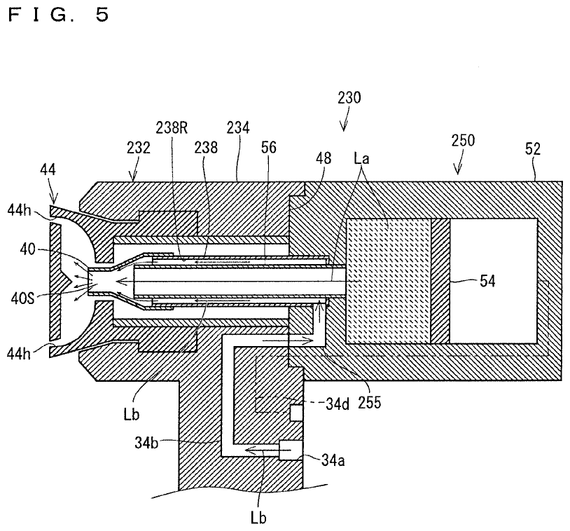

A coating device according to a third embodiment is described. FIG. 5 is a cross-sectional view illustrating a coating gun 230 according to the third embodiment. In the description of the present embodiment, the same reference numerals are assigned to the similar constituent elements described in the first embodiment, and the description thereof will be omitted.

The coating gun 230 according to the third embodiment has a configuration that a second coating liquid tube 238 and the mixing part 40 are provided to a cartridge 250 in place of the coating gun body 232 in the coating gun 30 according to the first embodiment.

That is to say, a through hole is formed in a body 234 corresponding to the body 34 in the coating gun body 232 corresponding to the coating gun body 32. One end part of the through hole in a longitudinal direction is larger than an intermediate part of the through hole in the longitudinal direction. The intermediate part and the other end part of the through hole in the longitudinal direction are larger than one end part of the through hole in the longitudinal direction. The second coating liquid tube 38 is omitted in the body 234.

In the body 234, an opening of the flow path 34b for flowing the second coating liquid Lb on a side opposite to the relay tube connection part 34a is opened on a side of the cartridge 250.

The second coating liquid tube 238 corresponding to the second coating liquid tube 38 is provided to the cartridge 250 corresponding to the cartridge 50. The second coating liquid tube 238 surrounds the lead-out tube 56 at intervals. A second coating liquid flow path 238R is formed between the second coating liquid tube 238 and the lead-out tube 56. A base end part of the second coating liquid tube 238 is embedded into the container body 52, thereby being supported by the container body 52. Herein, the opening on the side of the distal end of the lead-out tube 56 protrudes more than the opening on the side of the distal end of the second coating liquid tube 238, however, this configuration is not necessary.

Formed in the container body 52 is an internal relay path 255 reaching an inner side of the second coating liquid flow path 238R in the second coating liquid tube 238 from a position facing the opening on the side of the cartridge 250 in the flow path 34b described above. When the cartridge 250 is attached to the coating gun body 232, the flow path 34b and the internal relay path 255 are connected via a tube joint, for example. Then, the second coating liquid Lb supplied from the coating liquid supply source 60 via the relay tube 90 is supplied to the inner side of the second coating liquid flow path 238R via the flow path 34b and the internal relay path 255.

The mixing part 40 is continuously formed with the distal end of the second coating liquid tube 238. The configuration of the mixing part 40 itself may be the same as that described in the first embodiment. Thus, in the manner similar to the first embodiment, the first coating liquid La passing through the lead-out tube 56 and the second coating liquid Lb passing through the second coating liquid tube 238 join together in the mixing space 40S in the mixing part 40 and mixed.

The distal end of the mixing part 40 is inserted into the opening in the bottom of the bell cup 44 while the cartridge 250 is attached to the coating gun body 232. Thus, the liquids La and Lb mixed in the mixing part 40 is supplied to the jet 44h via the bell cup 44.

According to the present third embodiment, the mixing part 40 is also detached together when the cartridge 250 is detached from the coating gun body 232. Then, the other cartridge 250 is attached to the coating gun body 232 to perform a next coating operation. Thus, operability is improved.

The mixing part 40 provided to the detached cartridge 250 is exposed to an outer side than the mixing part 40 incorporated into the coating gun body 32 as the first embodiment. Thus, the operation of washing the mixing part 40 can be easily performed.

### Modification Example

In each embodiment described above, the bell cup 44 and the rotational drive part 47 described above may be omitted. In other words, the coating device, the cartridge, and the coating gun body described in the present embodiment may be used for a two-component mixing coating device other than an electrostatic coating. In this case, the distal end of the mixing part 40 may be exposed to one end side of the body 34. In this case, the liquid mixed in the mixing part 40 may be ejected from the opening on the side of the distal end of the mixing part 40 as a jet. The liquid mixed in the mixing part 40 may be ejected by the other nozzle having a jet.

In each embodiment, the liquid mixed by the mixing part 40 needs not be directly led into the bell cup 44. For example, the liquid mixed by the mixing part may be led into the bell cup via the other tube. It is not necessary for the mixing part 40 to have the above configuration. For example, the mixing part may be a static mixer having a fin agitating a fluid flowing in a flow path. For example, it is applicable that the mixing part 40 described above is omitted, and the first coating liquid La and the second coating liquid Lb are supplied to the inner side of the bell cup 44 from the lead-out tube 56 and the second coating liquid tube 38, and mixed in a space in the bell cup 44. In this case, the space in the bell cup 44 is the mixing space.

Described in each embodiment described above is an example that only one cartridge is attached to the gun body, however, it is also applicable that cartridges are detachably attached to the gun body, and the first coating liquids supplied from the cartridges and the second coating liquid supplied from the outside is mixed in the coating gun.

In each embodiment described above, the operation of replacing the cartridge in the gun body may be performed by manpower. It is also applicable that the cartridges 50 housing the different first coating liquids La are set near the transport body 80, and the cartridge 50 is replaced using a configuration similar to a tool replacement system in a robot. The liquid needs not be supplied from the cartridge by the configuration of pressing the liquid by a cylinder. For example, the liquid in the cartridge may be supplied by a pump incorporated into the gun body or the cartridge.

The coating device described in the second embodiment and the third embodiment described above can also be used as a processing liquid ejection system as described in the first embodiment, and the ejection method using the processing liquid ejection system can be achieved.

Each configuration in each embodiment and each modification example described above can be combined with each other as appropriate unless any contradiction occurs.

The foregoing description is in all aspects illustrative and does not restrict the present invention. It is understood that numerous unillustrated modifications can be devised without departing from the scope of the present invention.

The present specification and the drawings disclose each aspect described hereinafter.

A coating device according to a first aspect includes: a coating gun including a coating gun body provided with a jet and a cartridge detachably attached to the coating gun body and housing a first coating liquid; a transport body to which the coating gun is attached to move the coating gun to a predetermined coating position; and a relay tube provided to the transport body to connect a coating liquid supply source disposed in a position away from the coating gun and the coating gun so that a second coating liquid supplied from the coating liquid supply source can flow therethrough, wherein the cartridge includes a lead-out tube leading out the first coating liquid housed in the cartridge, and formed in the coating gun is a mixing space where the first coating liquid housed in the cartridge and the second coating liquid supplied from the coating liquid supply source are mixed is formed on a downstream side of the relay tube and the lead-out tube.

According to the coating device, a cartridge is replaced after a cartridge housing a different coating liquid is prepared, thus a mixed coating liquid ejected from the coating gun body can be easily varied in accordance with a coating form. The first coating liquid housed in the cartridge in two liquids to be mixed can be supplied to the coating gun body without intervention of the relay tube, thus a length of a path through which the first coating liquid flows can be reduced. The first coating liquid in the cartridge is mixed with the second coating liquid in the mixing space provided to the coating gun, and is ejected from the jet. The length of the path through which the first coating liquid flows is reduced, and the liquid is mixed in the coating gun, thus the region where the first coating liquid has flowed before the replacement of the cartridge can be reduced when the cartridge is replaced, and the region where the first coating liquid is washed before the replacement of the cartridge can be reduced in accordance with the replacement of the cartridge. Accordingly, the washing process can be reduced, and the time until the mixed coating material after the replacement of the cartridge is qualitatively stabilized can be reduced. A loss of a coating liquid can also be reduced.

A second aspect is the coating device according to the first aspect, wherein the first coating liquid corresponding to a change of a coating form of a coating target is housed in the cartridge, and a second coating liquid used in common even when the coating form of the coating target is changed is supplied via the relay tube.

In this case, the first coating liquid as part of the mixed coating liquid is housed in the cartridge in place of the mixed coating liquid to be ejected. The number of replacements of the cartridge is suppressed compared with the case where the mixed coating liquid is housed in the cartridge. The second coating liquid used in common even when the coating form of the coating target is changed is supplied via the relay tube, thus washing of the relay tube and the replacement of the liquid in the relay tube are unnecessary.

A third aspect is the coating device according to the first or second aspect, wherein the cartridge houses a base compound as the first coating liquid, and a cure agent is supplied as the second coating liquid via the relay tube.

Herein, when a coating operation associated with an operation of frequently changing a color is assumed, the cartridge housing the base compound is replaced in every operation of changing a color, and the coating liquid supply source housing the cure agent is continuously used regardless of the operation of changing a color. A time and effect other than the replacement of the cartridge 50 for changing a color such as the replacement of the coating liquid supply source caused by a lack of cure agent or an operation of resupplying the cure agent, for example, can be reduce as much as possible. Thus, both reduction of a residual amount of liquid of the base compound and reduction of the time and effect of the operation of supplying the cure agent can be achieved.

A fourth aspect is the coating device according to any one of the first to third embodiments, wherein the coating gun body is provided with the mixing space and a second coating liquid flow path leading a second coating liquid supplied from the coating liquid supply source via the relay tube toward the mixing space.

In this case, an amount of waste of an unused mixed coating liquid can be suppressed compared with a case where two coating liquids are previously mixed and then supplied to the coating device.

A fifth aspect is the coating device according to any one of the first to fourth aspects, wherein the cartridge includes a container body housing the first coating liquid, and the lead-out tube leads the first coating liquid in the container body toward the mixing space while the cartridge is attached to the coating gun body.

The lead-out tube can be replaced together with the container body of the cartridge, thus the operation of washing the coating gun body in the replacement of the cartridge is easily performed.

A sixth aspect is the coating device according to any one of the first to fifth aspect, wherein formed in the coating gun body is a washing liquid flow path through which a washing liquid, which washes at least a part of a flow path through which the first coating liquid flows, flows.

In this manner, when the washing liquid flow path is formed in the coating gun body, the operation of washing the coating gun is simplified.

A coating device according to a seventh aspect is the coating device according to any one of the first to third aspects, wherein the cartridge includes a container body housing the first coating liquid, formed in the cartridge is the mixing space in which the first coating liquid and the second coating liquid are mixed and a second coating liquid flow path leading the second coating liquid supplied from the coating liquid supply source via the relay tube toward the mixing space, the lead-out tube leads the first coating liquid in the container body toward the mixing space, and the first coating liquid and the second coating liquid mixed in the mixing space are supplied to the jet while the cartridge is attached to the coating gun body.

When the cartridge is detached from the coating gun body, the part forming the mixing space can also be detached together, thus operability is improved.

An eighth aspect is the coating device according to any one of the first to seventh aspects, wherein the coating gun includes a bell cup in which the jet is formed.

Accordingly, the mixed coating liquid can be atomized by the bell cup and ejected.

A ninth aspect is a cartridge detachably attached to a coating gun body provided with a jet including: a container body housing a first coating liquid; and a lead-out tube leading out the first coating liquid in the container body, wherein formed in the cartridge are a mixing space where the first coating liquid and the second coating liquid are mixed and a second coating liquid flow path leading the second coating liquid supplied from an outside of the cartridge toward the mixing space, and the lead-out tube leads the first coating liquid in the container body toward the mixing space.

According to the cartridge, the cartridge is replaced after the cartridge housing the different coating liquid is prepared, thus the mixed coating liquid ejected from the coating gun body can be easily varied. The first coating liquid housed in the cartridge in two liquids to be mixed can be supplied to the coating gun body without intervention of the relay tube, thus the length of the path through which the first coating liquid flows can be reduced. The first coating liquid in the cartridge is mixed with the second coating liquid in the mixing space provided to the cartridge, and is supplied to the coating gun body. The length of the path through which the first coating liquid flow is reduced, and the liquid is mixed in the coating gun, thus the region where the first coating liquid has flowed before the replacement of the cartridge can be reduced when the cartridge is replaced, and the region where the first coating liquid is washed before the replacement of the cartridge can be reduced in accordance with the replacement of the cartridge. Accordingly, the washing process can be reduced, and the time until the mixed coating material after the replacement of the cartridge is qualitatively stabilized can be reduced. A loss of a coating liquid can also be reduced.

The coating gun body according to a tenth aspect includes: an ejection part where a jet from which a coating liquid is ejected is formed; a cartridge attachment part to which a cartridge housing a first coating liquid can be detachably attached; and a relay tube connection part to which a relay tube supplying a second coating liquid from an outside is connected.

According to the coating gun body, a cartridge is replaced after a cartridge housing a different coating liquid is prepared, thus a mixed coating liquid ejected from the coating gun body can be easily varied. The first coating liquid housed in the cartridge in two liquids to be mixed can be supplied to the coating gun body without intervention of the relay tube, thus the length of the path through which the first coating liquid flows can be reduced. The first coating liquid in the cartridge is mixed with the second coating liquid, and is ejected from the jet. The length of the path through which the first coating liquid flows is reduced, and the liquid is mixed in the coating gun, thus the region where the first coating liquid has flowed before the replacement of the cartridge can be reduced when the cartridge is replaced, and the region where the first coating liquid is washed before the replacement of the cartridge can be reduced in accordance with the replacement of the cartridge. Accordingly, the washing process can be reduced, and the time until the mixed coating material after the replacement of the cartridge is qualitatively stabilized can be reduced. A loss of a coating liquid can also be reduced.

An eleventh aspect is a method of ejecting a mixture in a processing liquid ejection system including an ejection gun including an ejection gun body provided with a jet and a cartridge detachably attached to the ejection gun body and housing a first processing liquid and a processing liquid supply source disposed in a position away from an ejection gun and supplying a second processing liquid to an ejection gun body, wherein a mixture made up of the first processing liquid and the second processing liquid supplied from the processing liquid supply source on a downstream side of a lead-out tube leading out the first processing liquid housed in the cartridge is ejected.

According to the method of ejecting the mixture, a cartridge is replaced after a cartridge housing a different first processing liquid is prepared, thus a mixture ejected from the coating gun body can be easily varied. The first processing liquid housed in the cartridge in two liquids to be mixed can be supplied to the ejection gun body from the cartridge, thus a length of a path through which the first processing liquid flows can be reduced. The first processing liquid in the cartridge is mixed with the second processing liquid on the downstream side of the lead-out tube, and ejected from the jet. The length of the path through which the first processing liquid passes is small, and the liquid is mixed on the downstream side of the lead-out tube, thus a region where the first processing liquid has flowed before a replacement of the cartridge can be reduced when the cartridge is replaced, and a region where the first processing liquid is washed before the replacement of the cartridge can be reduced in accordance with the replacement of the cartridge. Accordingly, a washing process can be reduced, and a time until a mixture after the replacement of the cartridge is qualitatively stabilized can be reduced. A loss of a processing liquid can also be reduced.

### EXPLANATION OF REFERENCE SIGNS

20 coating device
30, 130, 230 coating gun (ejection gun)
32, 232 coating gun body (ejection gun body)
38, 238 second coating liquid tube
38R, 238E second coating liquid flow path
40, 40B, 140 mixing part
40S mixing space
44 bell cup (ejection part)
44h j et
48 cartridge attachment part
50, 250 cartridge
52 container body
56 lead-out tube
60 coating liquid supply source (processing liquid supply source)
80 transport body
90 relay tube
138 washing liquid tube
138R washing liquid flow path
La first coating liquid (first processing liquid)
La second coating liquid (second processing liquid)
Lc washing liquid

1. A coating device, comprising:
a coating gun including a coating gun body provided with a jet and a cartridge detachably attached to the coating gun body and housing a first coating liquid;
a transport body to which the coating gun is attached to move the coating gun to a predetermined coating position; and
a relay tube provided to the transport body to connect a coating liquid supply source disposed in a position away from the coating gun and the coating gun so that a second coating liquid supplied from the coating liquid supply source can flow therethrough, wherein
the cartridge includes a lead-out tube leading out the first coating liquid housed in the cartridge, and
formed in the coating gun is a mixing space where the first coating liquid housed in the cartridge and the second coating liquid supplied from the coating liquid supply source are mixed is formed on a downstream side of the relay tube and the lead-out tube.

2. The coating device according to claim 1, wherein
the first coating liquid corresponding to a change of a coating form of a coating target is housed in the cartridge, and
the second coating liquid used in common even when the coating form of the coating target is changed is supplied via the relay tube.

3. The coating device according to claim 1, wherein
the cartridge houses a base compound as the first coating liquid, and
a cure agent is supplied as the second coating liquid via the relay tube.

4. The coating device according to claim 1, wherein
the coating gun body is provided with the mixing space and a second coating liquid flow path leading a second coating liquid supplied from the coating liquid supply source via the relay tube toward the mixing space.

5. The coating device according to claim 1, wherein
the cartridge includes a container body housing the first coating liquid, and
the lead-out tube leads the first coating liquid in the container body toward the mixing space while the cartridge is attached to the coating gun body.

6. The coating device according to claim 1, wherein
formed in the coating gun body is a washing liquid flow path through which a washing liquid, which washes at least a part of a flow path through which the first coating liquid flows, flows.

7. The coating device according to claim 1, wherein
the cartridge includes a container body housing the first coating liquid,
formed in the cartridge is the mixing space in which the first coating liquid and the second coating liquid are mixed and a second coating liquid flow path leading the second coating liquid supplied from the coating liquid supply source via the relay tube toward the mixing space,
the lead-out tube leads the first coating liquid in the container body toward the mixing space, and
the first coating liquid and the second coating liquid mixed in the mixing space are supplied to the jet while the cartridge is attached to the coating gun body.

8. The coating device according to claim 1, wherein
the coating gun includes a bell cup in which the jet is formed.

9. A cartridge detachably attached to a coating gun body provided with a jet, comprising:
a container body housing a first coating liquid; and
a lead-out tube leading out the first coating liquid in the container body, wherein
formed in the cartridge are a mixing space where the first coating liquid and a second coating liquid are mixed and a second coating liquid flow path leading the second coating liquid supplied from an outside of the cartridge toward the mixing space, and
the lead-out tube leads the first coating liquid in the container body toward the mixing space.

10. A coating gun body, comprising:
an ejection part where a jet from which a coating liquid is ejected is formed;
a cartridge attachment part to which a cartridge housing a first coating liquid can be detachably attached; and
a relay tube connection part to which a relay tube supplying a second coating liquid from an outside is connected.

11. A method of ejecting a mixture in a processing liquid ejection system including an ejection gun including an ejection gun body provided with a jet and a cartridge detachably attached to the ejection gun body and housing a first processing liquid and a processing liquid supply source disposed in a position away from an ejection gun and supplying a second processing liquid to an ejection gun body, wherein
a mixture made up of the first processing liquid and the second processing liquid supplied from the processing liquid supply source mixed on a downstream side of a lead-out tube leading out the first processing liquid housed in the cartridge is ejected.
